(19) United States
(12) Patent Application Publication
(10) Pub. No.: US 2012/0262270 A1
(43) Pub. Date: Oct. 18, 2012

(54) SYSTEMS AND METHODS FOR ZONE-BASED SELECTION OF AIRPORT ACCESS POINT SECURITY FEATURES

(76) Inventor: Stephen L. McNally, Reston, VA (US)

(21) Appl. No.: 13/298,376

(22) Filed: Nov. 17, 2011

Related U.S. Application Data
(60) Provisional application No. 61/441,779, filed on Feb. 11, 2011.

(51) Int. Cl. G06F 7/04

(52) U.S. Cl. 340/5.52; 340/5.21; 340/5.6; 340/5.7

(57) ABSTRACT

Methods for configuring one or more access points between adjacent zones of different types at an airport facility are disclosed. One method includes determining an access point type based on a security level of a first zone on a first side of the access point and a second security level of a second zone on a second side of the access point. The method also includes selecting one or more security features for use at the access point. The method further includes applying the one or more security features at the first and second sides of the access point.

### CROSS REFERENCE TO RELATED APPLICATIONS

The present application claims priority to U.S. Provisional Patent Application No. 61/441,779, dated Feb. 11, 2011, the disclosure of which is hereby incorporated by reference in its entirety.

### TECHNICAL FIELDS

The present disclosure relates generally to selection and implementation of security features and access controls. In particular, the present disclosure relates to systems and methods for zone-based selection of airport access point security features.

### BACKGROUND

Airport facilities often have areas in which only authorized personnel are allowed to enter. Typically, some type of access control mechanism (key, keycard, or security feature) and monitoring device (e.g., a camera) is placed at entrances and exits to these areas of higher security. However, even with such controls in place, in some cases, unauthorized personnel can enter after a security check of that person.

For example, certain areas of an airport (e.g., ticketing, passenger drop-off and pick-up, baggage claim areas, etc.) are accessible to any individual without that individual being required to pass any security check. Other areas of the airport (e.g., terminals) are available only to ticketed passengers and authorized personnel. Ticketed passengers are subjected to a screening process prior to being allowed to enter these areas. Still other areas are available only to authorized personnel, such as airport employees, TSA, flight crews, maintenance crews, and others.

When designing a security system for an airport facility having different access levels and access requirements, different levels of security are required based on the possible individuals. Therefore, at each possible access point to an area having a particular security level, security features are placed to prevent unauthorized access.

Current security systems in airport facilities are designed on an ad-hoc basis. That is, each access point is assessed individually and security features are selected and applied to that access point given the circumstances relating to the access point (e.g., its location and expected traffic). This often results in use of a large number of security features placed at each access point (e.g., a security camera, access card reader, and other features). This larger number of security features results in a much larger amount of data collected by that facility, resulting in difficulties monitoring the various access points. Counter intuitively, including more security features at each of the access points available at an airport can in fact reduce the effectiveness of the security features by overwhelming personnel charged with oversight of the security features with video, photographic, access log, and other security information collected by the security features at the various access points of the airport.

Hence, no integrated, managed solution for providing security features at an airport facility is available to control security events throughout that airport facility.

### SUMMARY

In accordance with the following disclosure, the above and other issues are addressed by the following:

In a first aspect, a method for configuring one or more access points between adjacent zones of different types at an airport facility is disclosed. The method includes determining an access point type based on a security level of a first zone on a first side of the access point and a second security level of a second zone on a second side of the access point. The method also includes selecting one or more security features for use at the access point. The method further includes applying the one or more security features at the first and second sides of the access point.

In a second aspect, a method for configuring an access point between adjacent zones of different types at an airport facility is disclosed, and includes determining an access point type based on a security level of a first zone on a first side of the access point and a second security level of a second zone on a second side of the access point, wherein the security level of the first zone is determined based on authorization required to access the first zone, and the security level of the second zone is determined based on authorization required to access the second zone. The method also includes selecting one or more security features for use at the access point by applying a plurality of predetermined rules based on the determined access point type, wherein the one or more security features are selected from the group consisting of: a biometric reader; a card reader; a camera; and a door. The method further includes applying the one or more security features at the first and second sides of the access point.

In a third aspect, an airport is disclosed that includes a plurality of security zones, each security zone defined to be accessible to a different group of individuals. The airport includes a plurality of access points including at least one access point defined between adjacent zones of different types, the at least one access point being configured according to a access point type determined based on a security level of a first zone on a first side of the at least one access point and a second security level of a second zone on a second side of the at least one access point. The airport also includes one or more security features applied at the at least one access point, the one or more security features selected based on a plurality of predetermined rules associated with the determined access point type.

### BRIEF DESCRIPTION OF THE DRAWINGS

FIG. 1 is a schematic diagram of an example airport facility separated into a plurality of zones.

FIG. 2 illustrates an example flowchart of a method for configuring an access point between adjacent zones of different types at the facility of FIG. 1.

FIG. 3 illustrates an example flowchart of a method for determining whether a access point arranged between adjacent zones of different types at the airport facility receives access control equipment.

FIG. 4 is top view of a first example access point.

FIG. 5 is side view of the example access point of FIG. 4 including a door positioned thereto.

FIG. 6 is perspective view of a second example access point.

FIG. 7 shows an example networked communication environment in accordance with the present disclosure.

FIG. 8 is a block diagram illustrating example physical details of an electronic computing device, with which aspects of the present disclosure can be implemented.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

The present disclosure relates to systems and methods for zone-based selection of airport access point security features. In example embodiments described herein, the systems and methods are used to determine the configuration of new and existing access points within an airport. In general, access point configuration is optimized in that the quality of information acquired from a given access point is increased, while simultaneously minimizing both the number of features required to secure the access point and the volume of acquired information. Although not so limited, an appreciation of the various aspects of the disclosure will be gained through a discussion of the examples provided below.

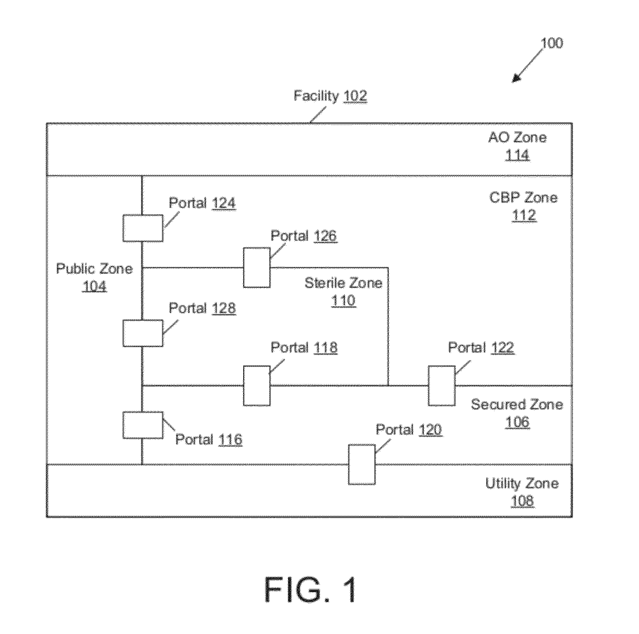

Referring now to FIG. 1, a schematic diagram 100 is shown illustrating an example airport facility 102 segmented into a plurality of zones in accordance with the present disclosure. In the example shown, the airport facility 102 is segmented into a public zone 104, a secured zone 106, a utility zone 108, a sterile zone 110, a Customs and Border Patrol (CBP) zone 112, and an Airport Operations (AO) zone 114. In general, a security level of each of the respective zones 104-114 is defined based on a type of authorization required for access.

For example, the public zone 104 is any non-secured area of the facility 102 that is freely accessible to the general public. In contrast, the secured zone 106 is any area of the airport facility 102 designated as a Security Identification Display Area (SIDA), in which access is denied to unauthorized individuals. The utility zone 108 is also any area of the airport facility 102 in which access is denied to unauthorized individuals, and is distinguished from the secured zone 106 based on type or form of credentials required for access. For example, access to the secured zone 106 may require identity verification via a Picture Archiving and Communication System (PACS), whereas access to the utility zone 108 may require identity verification via PACS and a biometric reader. Other embodiments are possible.

The sterile zone 110 is a terminal or concourse area of the airport facility 102 generally defined between initial passenger security screening by the TSA and any boarding gate(s). The CBP zone 112 is any area of the airport facility 102 designated for international passenger processing including corridors between jet bridges and primary passenger processing, typically accessed by individuals that have at least passed an initial security check. Lastly, the AO zone 114 is a SIDA area of the facility designated for aircraft movement, passenger planning and deplaning, and baggage loading/unloading. The AO zone 114 is distinguished from the secured zone 106, in that the secured zone 106 is not typically accessed by non-airport personnel.

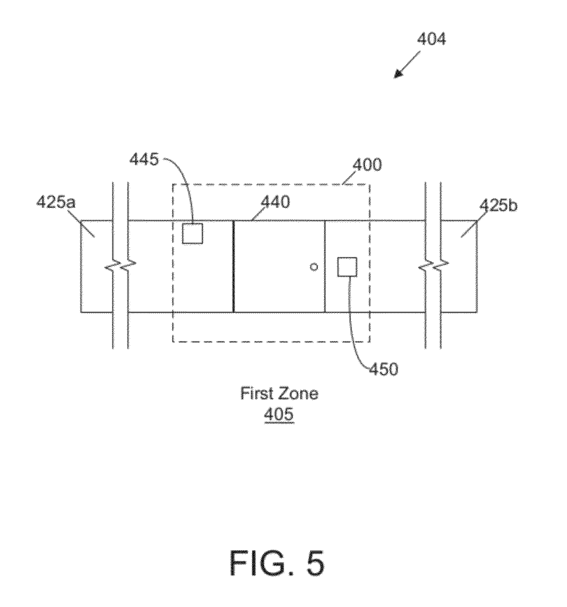

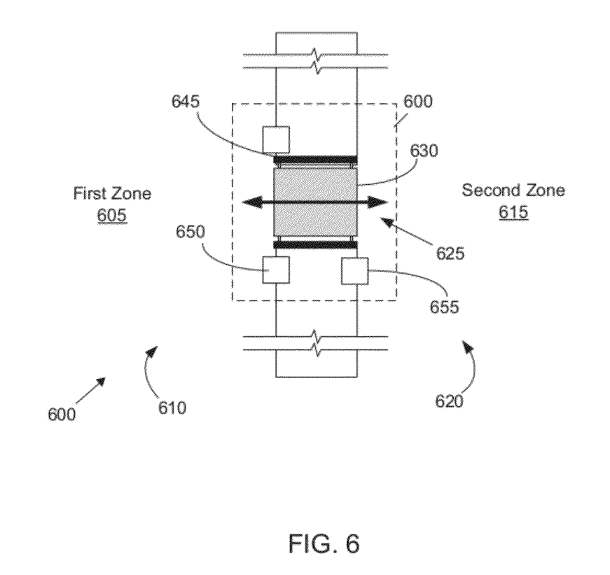

Still referring to FIG. 1, a security check point, or access point, can be selectively positioned between adjacent zones of the plurality of zones 104-114 for the purpose of controlling and/or limiting access between respective zones. As described in further detail below in connection with FIGS. 5-6, a given access point is configured with one or more security measures based on a security level of a first zone on a first side of the access point and a second security level of a second zone on a second side of the access point.

In the example shown, a public zone to secured zone (PSE) access point 116 is positioned between the public zone 104 and the secured zone 106 where access is controlled at least via PACS. Example locations for selective placement of the PSE access point 116 within the airport facility 102 include baggage doors, employee entrances, cargo facilities, landside equipment rooms, badging office(s), and administrative buildings. Other locations are possible as well.

A sterile zone to secured zone (STSE) access point 118 is positioned between the sterile zone 110 and the secured zone 106. Example locations for selective placement of the STSE access point 118 include jet bridge doors, concourse fire egress doors, airside equipment rooms within the sterile zone 110, and any door(s) that leads from the sterile zone 110 to the secured zone 106 where access is controlled via PACS. Other locations are possible.

A secured zone to utility zone (SEU) access point 120 is positioned between the secured zone 106 and the utility zone 108. In one embodiment, the utility zone 108 is a more tightly controlled secured area than the secured zone 106, and may or may not be located within the secured zone 106. Example locations for selective placement of the SEU access point 120 include TSA baggage screening rooms, maintenance doors, airside/landside equipment room doors, and/or any other type of door(s) that leads from a PACS controlled area to the secured zone 106. Other locations are possible.

A CBP zone to secured zone (CSE) access point 122 is positioned between the CBP zone 112 and the secured zone 106. Example locations for selective placement of the CSE access point 122 include CBP sterile corridor emergency exits, and/or any other access point between the CBP zone 112 and the secured zone 106 where access is controlled via PACS. Other locations are possible.

A CBP zone to public zone (CP) access point 124 is positioned between the CBP zone 112 and the public zone 104. Example locations for selective placement of the CP access point 124 included CBP administrative office doors, and/or any other access point between the CBP zone 112 and the public zone 104. Other locations are possible.

A CBP zone to sterile zone (CST) access point 126 is positioned between the CBP zone 112 and the sterile zone 110. Example locations for selective placement of the CST access point 126 include convertible gates, and/or any other access point that separates the CBP zone 112 and the sterile zone 110. Other locations are possible.

A public zone to sterile zone (PST) access point 128 is positioned between the public zone 104 and the sterile zone 110. Example locations for selective placement of the PST access point 128 include a Passenger Screening Security Checkpoint (PSSCP), and/or any access point that separates the public zone 104 and the sterile zone 110. Other locations are possible.

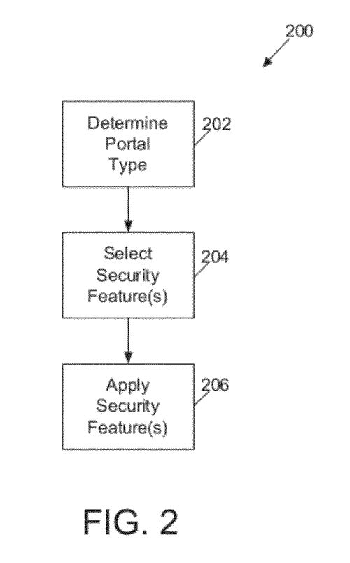

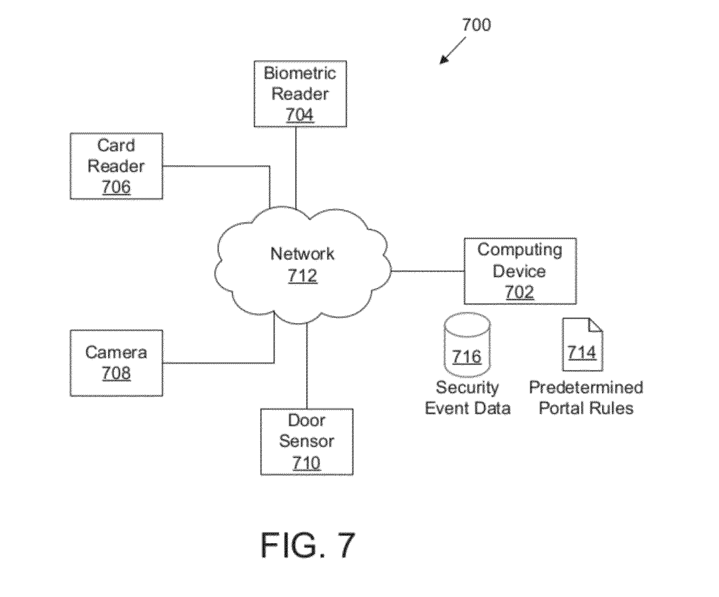

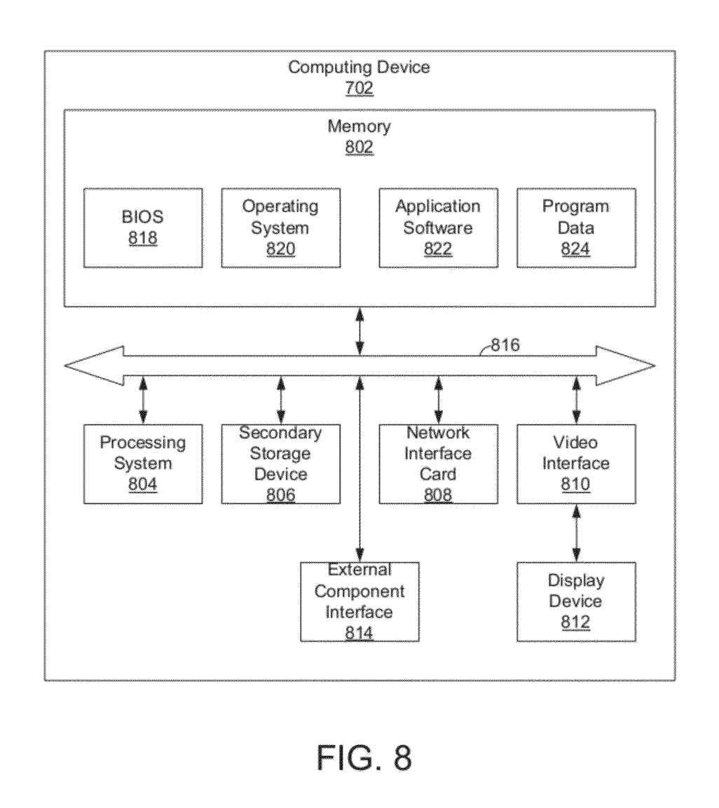

Referring now to FIG. 2, a flowchart of an example method 200 for configuring an access point located between adjacent zones of different types at the airport facility 102 of FIG. 1 is shown. The method 200 generally illustrates an example of an overall process for configuring of new and existing access points within the facility 102 based on type of adjacent zones that the access point separates. Example systems with which the method 200 can be performed are described below in connection with FIGS. 7-8.

The method 200 begins at a zone evaluation operation 202. The zone evaluation operation 202 corresponds to determining a type of access point that exists between the adjacent zones of different types. In general, access point type is determined based on a security level of a first zone on a first side of the access point and a second security level of a second zone a second side of the access point. For example, when the first zone is the public zone 104 (i.e., undefined security level) and the second zone is the secured zone 106 (i.e., heightened security level), the determined access point type would be the PSE access point 116 as defined above in connection with FIG. 1.

Operational flow proceeds to a rule evaluation operation 204. The operation 204 corresponds to selecting one or more security features for use at the access point by applying one or more predetermined rules that dictate those security features that are required, based on the type of access point determined at the zone evaluation operation 202. Continuing with the PSE access point 116 example, the one or more security features may include a biometric reader, a card reader, and/or a camera based on preexisting rules defined in a listing or table. An example of such a table is described in further detail below in connection with FIGS. 7-8.

Operational flow then proceeds to an access point outfitting operation 206. The operation 206 corresponds to applying the security features selected for use at the access point at the rule evaluation operation 204 to the access point. In general, placement of the selected security features relative to to the access point is dependent upon security feature type and the particular side or zone of the access point. For example the following security feature configuration or arrangement may apply to the PSE access point 116: placement of a biometric reader on a side of the access point within the public zone 104; placement of a card reader on both the side of the access point within the public zone 104, and a side of the access point within the secured zone 106; and placement of a camera on the side of the access point within the secured zone 106. Other embodiments are possible.

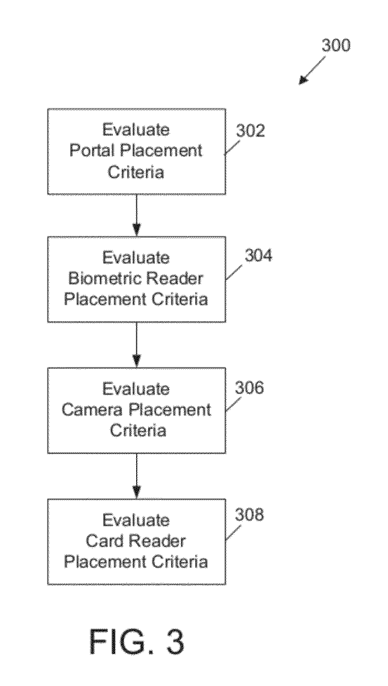

Referring now to FIG. 3, a flowchart of an example method 300 for determining whether or not to place a particular security feature at a given access point of the airport facility 102 of FIG. 1 is shown. The method 300 generally illustrates an example of an overall process for removing and/or applying security measures to a particular access point based on the severity of the security risk if an unauthorized individual gains access through the access point, and can result in development of the predetermined rules mentioned above in conjunction with FIG. 2. Example systems within which the method 300 can be performed are described below in connection with FIGS. 7-8.

The method 300 begins at an access point evaluation operation 302. The operation 302 corresponds to determining whether an existing access point within the facility 102 should be removed as being unnecessary. For example, if a given access point is infrequently used for operational purposes, and the zones separated by the access point are accessible through a nearby access point, then removal of the access point may be an option.

Benefits and advantages for access point removal are wide and varied and include, for example, an increase in security of the airport facility 102 by virtue of having fewer access points and/or security related events to monitor, and/or a reduction in cost(s) associated with operating and staffing the access point of interest.

Operational flow proceeds to a biometric evaluation operation 304. The operation 304 corresponds to determining whether a new or existing access point within the airport facility 102 should receive a biometric reader. Example biometric readers include an iris recognition device, a vein geometry (i.e., hand vascular) recognition device, or other types of biometric devices.

Placement of a biometric reader to a new or existing access point substantially increase security of the airport facility 102, as biometric readers typically require multiple levels of identity verification including, for example, credential verification (e.g., badge swipe), password verification (e.g., personal identification number), and physical characteristic verification (e.g., biometric data). In this manner, criteria or rules used for determining whether an access point within the airport facility 102 should receive a biometric reader at least include those areas where the severity of the security risk is highest if an unauthorized person gains access through the access point (e.g., PSE and PST access points 116, 128 which separate non-secure areas from secured areas are typically highest risk).

Operational flow then proceeds to a camera evaluation operation 306. The operation 306 corresponds to determining whether a new or existing access point should receive a camera having a field-of-view and focus primarily on a given access point. Any of a variety of types of cameras can be used, including closed-circuit, motion-activated, or other camera types.

Placement of a camera at a new or existing access point within the airport facility 102 is based on a number of criteria including, for example, evaluating the importance of directly observing or recognizing unauthorized persons entering secured spaces. For example, when a perpetrator circumvents an access point (sounding an alarm), a view typically needed of the front of the perpetrator as they go through the access point for the purpose of identifying the person. This would allow a dispatcher to provide a description of the perpetrator to a response force, and allow the dispatcher to determine which direction the perpetrator headed after going through the access point. In this example, cameras are placed on a secure side of the access point.

Another criteria for camera placement includes assessing whether or not the public, in large numbers, has access to a card reader on a particular side or zone of the access point. If this is the case, a camera may be necessary to ensure that perpetrators are not attempting to circumvent the card reader, allowing them to go through the access point without setting off an alarm. In this example, a camera may be placed on an unsecured side of the access point (e.g., within public zone 104) to assess the situation prior to an individual gaining unauthorized access to a secured side of the access point (e.g., secured zone 110).

Operational flow then proceeds to a card reader evaluation operation 308. The card reader evaluation operation 308 corresponds to determining whether a new or existing access point should receive a card reader. Determining which a access point should receive a card reader is performed by considering personnel who will be using the access point, and the areas they will be traveling to and from. For example, when an access point is separating a higher security area (e.g., CBP zone) from a lower security area (e.g., sterile zone) whereby both areas are controlled by the PACS, then a card reader may only be required on the lower security area side of the access point. Other embodiments are possible.

Upon processing access points of each of the types disclosed in connection with FIG. 1, operation of the methods of FIG. 3 can result in a set of predetermined rules that can be used in the context of the present disclosure to select and apply security features to a particular access point or set of access points at a secure facility such as an airport. Table 1, reproduced below in connection with FIG. 7, illustrates an example set of predetermined rules that can be used in connection with an airport such as that illustrated above in connection with FIG. 1.

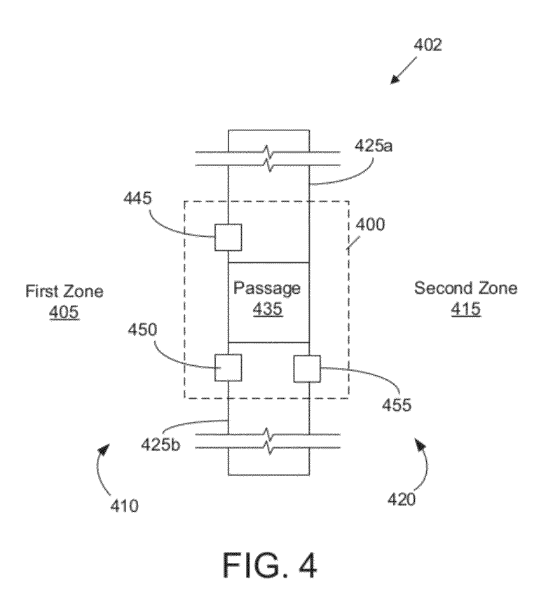

Referring now to FIGS. 4 and 5, a first example access point 400 is shown according to a possible embodiment of the present disclosure. FIG. 4 shows a top view 402 of the access point 400. FIG. 5 shows a first side view 404 of the access point 400. In general, the access point 400 is positioned within the facility 102 of FIG. 1, and is configured in accordance with the example methods 200, 300 described above in connection with FIGS. 2 and 3.

The access point 400 is a security check point arranged to control and/or limit access between a first zone 405 on a first side 410 of the access point 400 and a second zone 415 on a second side 420 of the access point 400. An authorized individual may access the first zone 405 from the second zone 415, and vice versa, through a passage 435 that is generally defined by a first barrier 425a and a second barrier 425b that partition the first zone 405 from the second zone 410.

In the example shown, the passage 435 is accessed via a door 440, which can be used to control access between adjacent zones connected by access point 400. The door 440 can optionally be controlled by a card reader 440 placed on one or both sides of the door (e.g., on a barrier 425 adjacent the passage 435). In the embodiment shown, card readers 440, 445 are placed on opposed sides of the door. Optionally, one or both of the card readers 440, 445 could be replaced by a biometric reader (e.g., a fingerprint, palm, or retina scanner, or some other type of reader). Whether or not one or both of the card readers 440, 445 are biometric readers may be dictated by the particular security level of the adjacent zones 405, 415, as illustrated in Table 1, below.

In some embodiments, a camera 450 is also linked to the door 440 through software so that, if an access point alarms, images captured by that camera 440 can and will be automatically displayed to the person monitoring alarms, for example at a central security location within the secure facility. Cameras can be placed on either side of the access point or both sides of the access point depending on the type of access point.

It is noted that a variety of other features may be present at the access point, and which may dictate the specific security features employed. In some embodiments, the access point may include an inbound or outbound belt transporting equipment (e.g., luggage) from one zone to another. In another example, the access point may lack a door, such as at a bag screening location. In such an example, additional security features, such as additional cameras, may be employed.

Referring now to FIG. 6, a further example access point 600 is shown. The access point 600 illustrates one example arrangement where no door is present, and therefore certain exceptions to a set of predetermined rules defining security features may be employed. In the embodiment shown, the access point 600 is positioned between a first zone 605 on a first size 610, and a second zone 615 on a second size 620. The access point includes a passage 625 and associated belt 630 for transporting items (e.g., luggage) between the zones.

In this arrangement, security concerns are likely different from those at the access point 400 of FIG. 4-5, at least because (1) no door is present, and (2) the access point 600 is typically placed adjacent a public or sterile security zone, for example to allow for receipt/dispersal of baggage to passengers at an airport (e.g., at a bag check or baggage claim area). In such arrangements, one or more card readers 645, 655 and cameras 650 may be employed, but biometric scanners may not be necessary, since a variety of individuals will typically access baggage on the “lower” security side of the access point 600. Other arrangements may be possible as well, depending upon the particular needs and layout of the airport facility, as well as the individuals authorized to be in one or both of the first and second zones 605, 615.

Referring now to FIG. 7, an example networked computing environment 700 is shown in which aspects of the present disclosure may be implemented. The example networked computing environment 700 includes a computing device 702, biometric reader 704, a card reader 706, a camera 708, a door sensor 710, and a network 712. Other embodiments of the networked computing environment 700 are possible. For example, the networked computing environment 700 may generally include more or fewer devices, networks, and other components as desired.

In general the networked computing environment 700 can be installed throughout an airport facility such that an operator of a computing device 702 can monitor security events collected from the various types of security features positioned at access points throughout that airport facility. The computing device 702 can be any of a number of types of server-based or other types of computing devices configured to collect data associated with security events, such as card reader or biometric scanner access records, door access records, video surveillance data, or other information. An example computing device useable as device 702 is described further below in connection with FIG. 8.

The network 712 is a bi-directional data communication path for data transfer between one or more devices. In the example shown, the network 220 establishes a communication path for data transfer between the computing device 702, biometric reader 704, a card reader 706, a camera 708, a door sensor 710. In general, the network 712 can be of any of a number of wireless or hardwired WAN, LAN, Internet, or other packet-based communication networks such that data can be transferred among the elements of the example networked computing environment 200. Other embodiments of the network 712 are possible as well.

A set of predetermined access point rules 714 can be stored at the computing device or otherwise maintained by the facility at which the networked environment resides. The predetermined access point rules 714 can be defined in a table or other data structure, and can be used by facility personnel to implement security features at that facility. Table 1, provided below, illustrates an example set of predetermined rules that can be employed at an airport facility to provide an integrated, facility-wide security arrangement that is coordinated based on the type of access point to which features are applied and to ensure that relevant security concerns are identified:

TABLE 1
Example Set of Predetermined Rules for Access Point Security Features

| | Access Point | | | | Remove | | |
|---|---|---|---|---|---|---|---|
| ID | Type | Bio | Reader | Camera | Door | Exceptions | Examples |
| 1 | Public to | Y | Public | Secured | Y (if | Inbound Belt/Oversized: card | Operational Doors |
| | Secured | | | | possible) | reader on Secured side, | (Baggage Claim, |
| | | | | | | camera secured side, no | Employee Entrance, etc.) |
| | | | | | | biometric; Outbound | |
| | | | | | | Belt/Oversized: card reader | |
| | | | | | | on public side, camera on | |
| | | | | | | public side, no biometric | |
| 2 | Sterile to | N | Sterile | Secured | Y (if | Fire Egress Doors: readers | Jet Bridges, Concourse |
| | Secured | | | | possible) | both sides, cameras both | Fire Egress |
| | | | | | | sides; Jet Bridge Doors: card | |
| | | | | | | reader on sterile side, camera | |
| | | | | | | on sterile side | |
| 3 | Secured to | N | Secured | Secured | Y (if | Airport | Airport |
| | Utility | | | | possible) | Operations/Maintenance/TSA | Operations/Maintenance |
| | Rooms | | | | | Bag Screening: card reader | Doors, Equipment |
| | | | | | | on the Secured side, camera | Rooms, TSA Baggage |
| | | | | | | on the utility room side | screening |
| 4 | CBP FIS to | N | Secured | Secured | Y (if | Operationally necessary: card | CBP Sterile Corridor |
| | Secured | | | | possible) | reader for turning off local | Emergency Exit |
| | | | | | | enunciator | |
| 5 | CBP FIS to | N | CBP FIS | None | N | | CBP Admin |
| | Public | | | | | | |
| 6 | CBP FIS to | N | Both | Sterile | Y (if | | Convertible Gates |
| | Sterile | | | | possible) | | |
| 7 | Public to | N | None | None | N | Operational Doors: card | Passenger Screening |
| | Sterile | | | | | readers on both sides, camera | Security Checkpoint |
| | | | | | | on sterile side, biometric on | |
| | | | | | | public side | |

Other combinations of security features could be implemented as well.

Additionally, a database 716 of security events allows the computing device 702 to aggregate security events occurring throughout the facility, for example for auditing the effectiveness of the security features placed at the access points in the facility, and to allow a user to monitor for security breaches at the facility. Through use of the set of predetermined access point rules 714, the volume of data collected in the database 716 is tuned to provide a manageable set of information for security personnel at the facility.

In the example of FIG. 8, the computing device 702 of FIG. 7 is shown in detail. As mentioned above, the computing device 702 is a computing device. In example embodiments, the computing device 702 includes a memory 802, a processing system 804, a secondary storage device 806, a network interface card 808, a video interface 810, a display unit 812, an external component interface 814, and a communication medium 816. The memory 802 includes one or more computer storage media capable of storing data and/or instructions. In different embodiments, the memory 802 is implemented in different ways. For example, the memory 802 can be implemented using various types of computer storage media.

The processing system 804 includes one or more processing units. A processing unit is a physical device or article of manufacture comprising one or more integrated circuits that selectively execute software instructions. In various embodiments, the processing system 804 is implemented in various ways. For example, the processing system 804 can be implemented as one or more processing cores. In another example, the processing system 804 can include one or more separate microprocessors. In yet another example embodiment, the processing system 804 can include an application-specific integrated circuit (ASIC) that provides specific functionality. In yet another example, the processing system 804 provides specific functionality by using an ASIC and by executing computer-executable instructions.

The secondary storage device 806 includes one or more computer storage media. The secondary storage device 806 stores data and software instructions not directly accessible by the processing system 804. In other words, the processing system 804 performs an I/O operation to retrieve data and/or software instructions from the secondary storage device 806. In various embodiments, the secondary storage device 806 includes various types of computer storage media. For example, the secondary storage device 806 can include one or more magnetic disks, magnetic tape drives, optical discs, solid state memory devices, and/or other types of computer storage media.

The network interface card 808 enables the computing device 702 to send data to and receive data from a communication network. In different embodiments, the network interface card 808 is implemented in different ways. For example, the network interface card 808 can be implemented as an Ethernet interface, a token-ring network interface, a fiber optic network interface, a wireless network interface (e.g., WiFi, WiMax, etc.), or another type of network interface.

The video interface 810 enables the computing device 702 to output video information to the display unit 812. The display unit 812 can be various types of devices for displaying video information, such as a cathode-ray tube display, an LCD display panel, a plasma screen display panel, a touch-sensitive display panel, an LED screen, or a projector. The video interface 810 can communicate with the display unit 812 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 814 enables the computing device 702 to communicate with external devices. For example, the external component interface 814 can be a USB interface, a FireWire interface, a serial port interface, a parallel port interface, a PS/2 interface, and/or another type of interface that enables the computing device 702 to communicate with external devices. In various embodiments, the external component interface 814 enables the computing device 702 to communicate with various external components, such as external storage devices, input devices, speakers, modems, media player docks, other computing devices, scanners, digital cameras, and fingerprint readers.

The communications medium 816 facilitates communication among the hardware components of the computing device 702. In the example of FIG. 8, the communications medium 816 facilitates communication among the memory 802, the processing system 804, the secondary storage device 806, the network interface card 808, the video interface 810, and the external component interface 814. The communications medium 816 can be implemented in various ways. For example, the communications medium 816 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing System Interface (SCSI) interface, or another type of communications medium.

The memory 802 stores various types of data and/or software instructions. For instance, in the example of FIG. 8, the memory 802 stores a Basic Input/Output System (BIOS) 818 and an operating system 820. The BIOS 818 includes a set of computer-executable instructions that, when executed by the processing system 804, cause the computing device 702 to boot up. The operating system 820 includes a set of computer-executable instructions that, when executed by the processing system 804, cause the computing device 702 to provide an operating system that coordinates the activities and sharing of resources of the computing device 702. Furthermore, the memory 802 stores application software 822. The application software 822 includes computer-executable instructions, that when executed by the processing system 804, cause the computing device 702 to provide one or more programs for use. The memory 802 also stores program data 824. The program data 824 is data used by programs that execute on the computing device 702.

The term computer readable media as used herein may include computer storage media and communication media. Computer storage media is distinguished from communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data.

By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Overall, a number of advantages of the methods and systems of the present disclosure exist. For example, the present disclosure provides an integrated security plan for an airport facility, which allows security personnel at that facility to readily identify security features required at each access point, and to capture only relevant security events at the monitored access points. This results in greater security effectiveness overall, due to controlled amounts of security event data collected and correlated, and due to selection of appropriate security features for each access point based on the identities of individuals wishing to pass through that access point (as defined by the individuals authorized to be in the security zones separated by that access point). Other advantages exist as well.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders.

The above specification, examples and data provide a complete description of the manufacture and use of the composition of the invention. Since many embodiments of the invention can be made without departing from the spirit and scope of the invention, the invention resides in the claims hereinafter appended.

1. A method for configuring an access point between adjacent zones of different types at an airport facility, the method comprising:
determining an access point type based on a security level of a first zone on a first side of the access point and a second security level of a second zone on a second side of the access point;
selecting one or more security features for use at the access point; and
applying the one or more security features at the first and second sides of the access point.

2. The method of claim 1, further comprising selecting the one or more security features by applying a plurality of predetermined rules based on the determined access point type.

3. The method of claim 1, wherein the one or more security features are selected from the group consisting of: a biometric reader; a card reader; a camera; and a door.

4. The method of claim 1, further comprising determining the security level of the first zone based on authorization required to access the first zone, and determining the security level of the second zone based on authorization required to access the second zone.

5. The method of claim 4, further comprising selecting the one or more security features applied at the first and second sides of the access point based on the determined security levels of the first zone and the second zone.

6. The method of claim 5, wherein an access point type is selected from the group consisting of: a public zone to secured zone type; a sterile zone to secured zone type;
secured zone to utility zone type; a CBP zone to secured zone type; a CBP zone to public zone type; a CBP zone to sterile zone type; and a public zone to sterile zone type.

7. The method of claim 6, wherein a public zone is a non-secured area of an airport accessible to all individuals, a secured zone and a utility zone are areas of the airport accessible to individuals defined in an authorization approval system, a sterile zone is an area of an airport facility accessible to individuals beyond passenger screening up to boarding gates, and a CBP zone is an area of the airport accessible to individuals for international travel processing.

8. The method of claim 7, wherein a public zone to secured zone access point type includes one or more security features, the one or more security features including a biometric reader; a card reader; and a camera.

9. The method of claim 7, wherein a sterile zone to secured zone type, a secured zone to utility zone type, and a CBP zone to sterile zone type include one or more security features, the one or more security features including a card reader and a camera.

10. The method of claim 7, wherein a CBP zone to public zone type includes one or more security features, the one or more security features including a card reader and a door.

11. The method of claim 7, wherein a public zone to sterile zone type includes a door.

12. A method for configuring an access point between adjacent zones of different types at an airport facility, the method comprising:
determining an access point type based on a security level of a first zone on a first side of the access point and a second security level of a second zone on a second side of the access point, wherein the security level of the first zone is determined based on authorization required to access the first zone, and the security level of the second zone is determined based on authorization required to access the second zone;
selecting one or more security features for use at the access point by applying a plurality of predetermined rules based on the determined access point type, wherein the one or more security features are selected from the group consisting of: a biometric reader; a card reader; a camera; and a door; and
applying the one or more security features at the first and second sides of the access point.

13. The method of claim 12, wherein an access point type is selected from the group consisting of: public zone to secured zone type; sterile zone to secured zone type; secured zone to utility zone type; CBP zone to secured zone type; CBP zone to public zone type; CBP zone to sterile zone type; and public zone to sterile zone type.

14. The method of claim 13, wherein a public zone is a non-secured area of the airport facility accessible to all individuals, a secured zone and a utility zone are areas of the airport facility accessible to individuals defined in an authorization approval system, a sterile zone is an area of the airport facility accessible to individuals beyond passenger screening up to boarding gates, and a CBP zone is an area of the airport facility accessible to individuals for international travel processing.

15. The method of claim 14, wherein a public zone to secured zone access point type includes one or more of the biometric reader; card reader, and camera security features.

16. The method of claim 14, wherein a sterile zone to secured zone type, a secured zone to utility zone type, and a CBP zone to sterile zone type include one or more of the card reader, and camera security features.

17. The method of claim 14, wherein a CBP zone to public zone type includes one or more of the card reader and door security features.

18. The method of claim 14, wherein a public zone to sterile zone type includes the door security feature.

19. The method of claim 12, further comprising aggregating, at a security event server, data relating to security events occurring at the access point.

20. An airport, comprising:
a plurality of security zones, each security zone defined to be accessible to a different group of individuals;
a plurality of access points including at least one access point defined between adjacent zones of different types, the at least one access point being configured according to a access point type determined based on a security level of a first zone on a first side of the at least one access point and a second security level of a second zone on a second side of the at least one access point; and
one or more security features applied at the at least one access point, the one or more security features selected based on a plurality of predetermined rules associated with the determined access point type.

21. The airport of claim 20, wherein the security level of the first zone is determined based on authorization required to access the first zone, and the second security level of the second zone is determined based on authorization required to access the second zone, and wherein access point type is selected from the group consisting of: public zone to secured zone type; sterile zone to secured zone type; secured zone to utility zone type; CBP zone to secured zone type; CBP zone to public zone type; CBP zone to sterile zone type; and public zone to sterile zone type.

22. The airport of claim 20, further comprising a security event server communicatively connected to at least some of the one or more security features, the security event server configured to aggregate data relating to security events at the at least one access point.
